(19) United States
(12) Patent Application Publication
(10) Pub. No.: US 2007/0083511 A1
(43) Pub. Date: Apr. 12, 2007

(54) Finding similarities in data records

(75) Inventors: Rahul Kapoor, Bellevue, WA (US); Yi Mao, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/247,604

(22) Filed: Oct. 11, 2005

(51) Int. Cl. G06F 17/30

(52) U.S. Cl. 707/6

(57) ABSTRACT

System(s) and/or method(s) (“tools”) are described that enable actions to be reused that are common to multiple similarity functions. The tools may do so, in one embodiment, by composing similarity functions into a single, composed function that performs actions once that are common to multiple similarity functions. This composed function may also permit data to be analyzed in one pass and/or render unnecessary a merge operation. The tools may also enable actions to be reused when a similarity function is performed multiple times. The tools may do so, in one embodiment, by retaining a result of performing an action and using that result when performing the similarity function again. The tools may also enable records to be compared using a flip-window algorithm. This algorithm may be an efficient way in which to compare records in a table to determine which of those records are similar or duplicates.

### BACKGROUND

Data records often contain errors. Two records may refer to a particular item in two different ways, for instance. Or two records may look different, but actually refer to one item. These errors can cause problems for people relying on these records. Assume that a company wants to send catalogs to all of its customers. Assume also that the company's database has two records for the same customer, like “Jane Doe, 123 W. American St., 90005” and “Jane T. doe, West 123 American Street, 90005”. If the company does not know that these two records refer to one customer, not two, it may send Jane Doe two catalogs.

Some current software techniques attempt to find these kinds of errors by comparing records using similarity functions. Current techniques might execute one similarity function on two records to determine whether or not the records are the same if white spaces and punctuation are removed from both records. Current techniques might then execute another similarity function on the same two records to determine whether or not the records are the same if both records are all caps or are not capitalized. Current techniques might then execute another similarity function on the same two records to determine whether or not the records are the same if common word strings are truncated. For the above example, performing each of these similarity functions might result in the first record looking like: “janedoe123wamericanst90005” and the second record looking the same (truncating West to “w” and Street to “st”). These records may then be recognized as referring to the same entity.

### SUMMARY

System(s) and/or method(s) (“tools”) are described that enable actions to be reused that are common to multiple similarity functions. The tools may do so, in one embodiment, by composing similarity functions into a single, composed function that performs actions once that are common to multiple similarity functions. This composed function may also permit data to be analyzed in one pass and/or render unnecessary a merge operation. The tools may also enable actions to be reused when a similarity function is performed multiple times. The tools may do so, in one embodiment, by retaining a result of performing an action and using that result when performing the similarity function again.

The tools may also enable records to be compared using a flip-window algorithm. This algorithm may be an efficient way in which to compare records in a table to determine which of those records are similar or duplicates.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an exemplary operating environment in which various embodiments can operate.

FIG. 2 illustrates three exemplary similarity functions and six constituent actions.

FIG. 3 is an exemplary process for composing and/or executing actions of similarity functions.

FIG. 4 illustrates an exemplary composed function.

FIG. 5 illustrates the composed function of FIG. 4 along with similarity functions from which the composed function was composed.

FIG. 6 illustrates an exemplary set of five data records and two of the records after processing.

FIG. 7 illustrates the data records of FIG. 6 after further processing.

FIG. 8 is an exemplary process for finding duplicate records using a flip-window algorithm.

FIG. 9 illustrates an exemplary set of 30 data records having three windows.

The same numbers are used throughout the disclosure and figures to reference like components and features.

### DETAILED DESCRIPTION

Overview

The following document describes tools that enable, in some embodiments, actions to be reused that are common to multiple similarity functions or can be performed multiple times by the same similarity function. The tools may, in one embodiment, compose similarity functions into a single, composed function comprising actions of multiple similarity functions. The tools may also, in another embodiment, retain a result of performing an action to use that result when re-performing a same similarity function. The tools may also, in still another embodiment, compare records in a table using a flip-window algorithm.

An environment in which these tools may enable these and other techniques is set forth first below. This is followed by others sections describing various inventive techniques and exemplary embodiments of the tools. One, entitled Composing and/or Executing Actions of Similarity Functions, describes an exemplary process for composing and executing actions of similarity functions, which may permit actions to be reused. Another, entitled Flip-Window Algorithm, describes an exemplary process enabling comparison of records in a table, which may reduce how many record pairs are analyzed.

Exemplary Operating Environment

Before describing the tools in detail, the following discussion of an exemplary operating environment is provided to assist the reader in understanding one way in which various inventive aspects of the tools may be employed. The environment described below constitutes but one example and is not intended to limit application of the tools to any one particular operating environment. Other environments may be used without departing from the spirit and scope of the claimed subject matter.

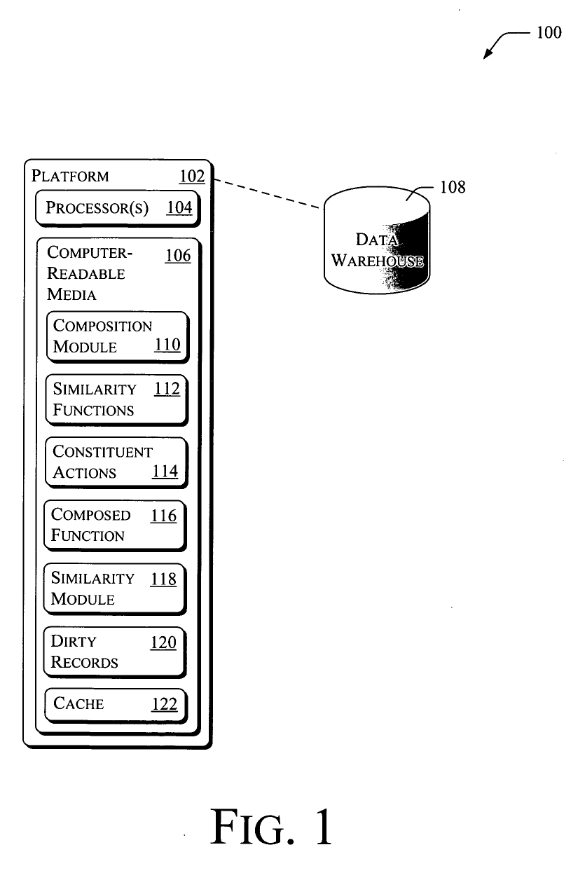

FIG. 1 illustrates one such operating environment generally at 100 comprising a platform 102 having one or more processor(s) 104 and computer-readable media 106. The platform may comprise part of, one, or multiple computing devices. The platform is capable of interacting with a data warehouse 108, such as to receive dirty data records and store cleansed data records.

The platform's processors are capable of accessing and/or executing the computer-readable media. The computer-readable media comprises or has access to a composition module 110, similarity functions 112, constituent actions 114, composed function 116, similarity module 118, dirty records 120, and cache 122.

Each similarity function is capable of determining a similarity between data records or parts of data records (e.g., records of dirty records 120). To do so, the similarity functions may comprise one or more constituent actions 114. These constituent actions may be used, in some embodiments, to build the similarity functions, such as responsive to selection by a user. Some of these actions may also be customized, and thus similarity functions be made extensible to provide additional functionality. Particular industries, such as the pharmaceutical industry, may have particular needs and peculiarities for data. Most industries may need similarity functions that can determine that two words with different cases are similar if they have the same characters, e.g., that “help” is similar to “Help” and “HELP”. But data may have peculiarities in an industry, such as in the pharmaceutical industry where “20 mg” should be considered similar to “0.02 g”. These actions may therefore enable custom identifications of industry-specific data similarities by alteration or selection of a particular action.

These actions may also perform operations useful to multiple similarity functions, such as two similarity functions that require tokenization. Having similarity functions that comprise a same action where that same action is separately executable may enable same actions to be reused (e.g., performed once rather than multiple times) when executing multiple different similarity functions.

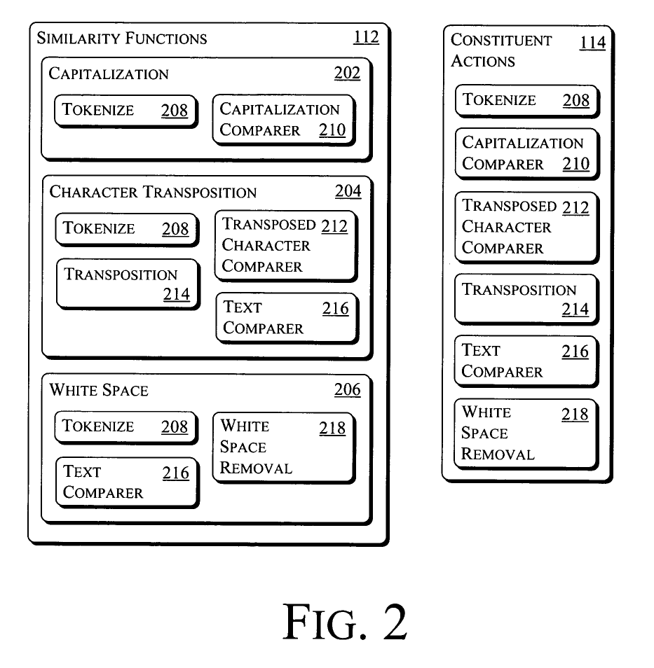

FIG. 2 illustrates three exemplary similarity functions and six constituent actions. Similarity functions 112 are shown with capitalization function 202, character transposition function 204, and white space function 206. Each of these functions comprises actions. Capitalization function 202 comprises a tokenize action 208 and a capitalization comparer action 210. Character transposition function 204 comprises tokenize action 208, a transposed character comparer action 212, transposition action 214, and text comparer action 216. White space function 206 comprises tokenize action 208, white space removal action 218, and the text comparer action 216. Each of these similarity functions may determine a similarity between data in records, such as a string of characters that are not identical but would be if capitalization were ignored (capitalization function 202).

Constituent actions 114 are shown with actions comprised by the exemplary similarity functions, here: tokenize action 208; capitalization comparer action 210; transposed character comparer action 212; transposition action 214; 11 text comparer action 216; and white space removal action 218.

Returning to FIG. 1, composition module 110 is capable of building composed function 116 from similarity functions 112 and/or constituent actions 114. The composed function is capable of effectuating the actions of two or more of the similarity functions without need of a merge function to merge the results of each similarity function. If each of the similarity functions is performed separately, they may each show a set of records that each has determined to be similar. To find those records shown to be similar by both functions, these sets may be merged to find a set of records that is a collision of both records. The composed function, however, is capable of giving a result that does not need to be merged. Instead, it may give a result that is equivalent to separate performance of each of the similarity functions (of which the composed function is a composition) and a merge function to merge their results.

Similarity module 118 is capable of executing the similarity functions, actions, and/or composed function to determine similarities between data records. The similarity module may do so according to various algorithms, such as a sliding window algorithm or a flip-window algorithm (set forth in greater detail below).

Dirty records 120 comprise data records to be analyzed for similarities. It may be received from data warehouse 108 in a table or other type of format. Data warehouse 108 may be ERP-dependent or independent. Cache 122 is capable of storing results of various actions, such as tokenized data resulting from tokenize action 208, for later use or storage.

Composing and/or Executing Actions of Similarity Functions

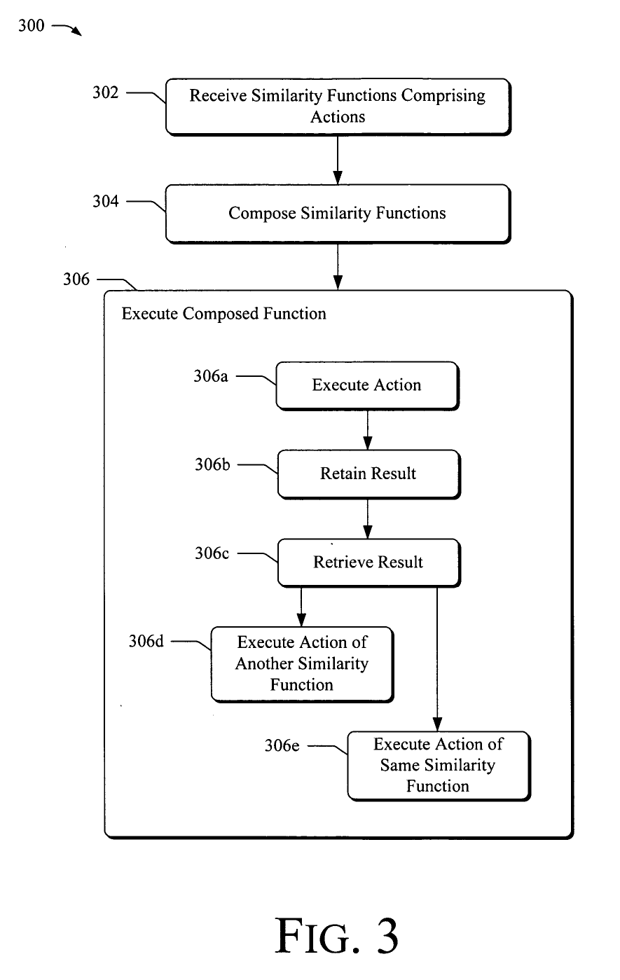

FIG. 3 is an exemplary process 300 for composing and/or executing actions of similarity functions. It may be performed as part of deduping (removing duplicates) or data cleansing operations of an extract, transform, and load (ETL) process or otherwise. It is illustrated as a series of blocks representing individual operations or acts performed by elements of operating environment 100 of FIG. 1, such as composition module 110 and similarity module 118. This and other processes herein may be implemented in any suitable hardware, software, firmware, or combination thereof; in the case of software and firmware, these processes represent sets of operations implemented as computer-executable instructions stored in computer-readable media and executable by one or more processors.

Block 302 receives similarity functions comprising actions. One or more of these similarity functions may comprise a same action or they may all comprise different actions. Each of the similarity functions may also produce results that may be merged with a post-performance merge operation into a single result. These similarity functions may be those selected or altered by a user, such as with an industry-specific similarity function (or constituent action) capable of determining that “20 mg” is similar to “0.02 g”. In so doing, the tools enable fine-grain control of what is and is not deemed similar, here with a logical primitive deeming “20 mg” a duplicate of “0.02 g”. In an exemplary embodiment, composition module 110 receives the three similarity functions 202, 204, and 206 shown in FIG. 2.

Block 304 composes similarity functions. Block 304 may produce a single, composed function capable of producing a same result as separate performance of each of the similarity functions and merging of the results from each. Block 304 may compose these similarity functions by determining which actions are comprised by the similarity functions and then ordering those actions into a single function. In some cases one or more of the actions of the similarity functions will be the same. The extra, redundant actions may then be excluded from the composed function. If this is done, the composed function may require fewer resources to perform a same result as performance of each of the similarity functions of which the composed function is a composition. The composed function, in effect, reuses actions that are redundant by performing the redundant action once and retaining the result for future input or output to other actions.

Also, the composed function may be performed with one pass over the data. Multiple passes over data may take more resources than one pass, which permits the composed function to require fewer resources (in some cases) than the multiple similarity functions. This composed function may be capable of being performed without need of a merge function to merge results of different similarity functions.

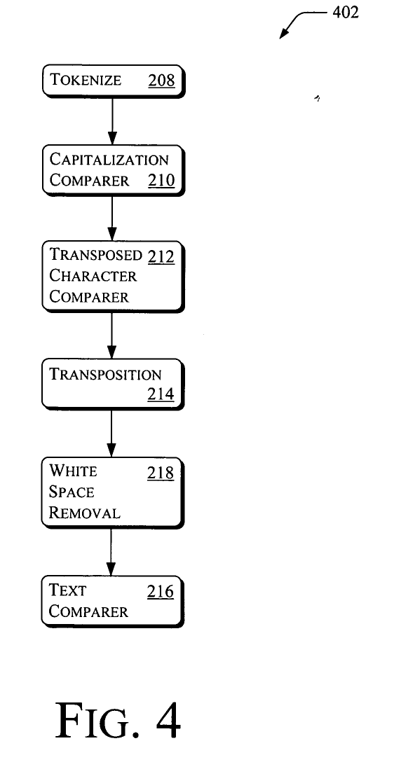

Here composition module 110 determines the actions comprised by similarity functions 202, 204, and 206. The constituent actions of these three functions are shown in FIG. 2 and numbered 208, 210, 212, 214, 216, and 218. The resulting composed function is capable of performing each of these actions and is shown in FIG. 4. Here composed function 402 comprises one of each action 208, 210, 212, 214, 216, and 218. Performance of this composed function only requires executing tokenize action 208 and text comparer action 216 once.

Block 306 executes a composed function of two or more similarity functions. The tools may perform the composed function in one pass, thereby not needing to separately merge results from two or more similarity functions and not having to touch the data multiple times. Here performing each of the three similarity functions received would result in three sets of results that may then be merged in a separate operation. Similarity module 118 may execute the composed function without needing to merge results from multiple similarity functions.

Manners in which the actions of the composed function may be executed are described in greater detail with subblocks shown internal to block 306. These subblocks may be effective to perform block 306 as described above or may instead by an alternative to block 306.

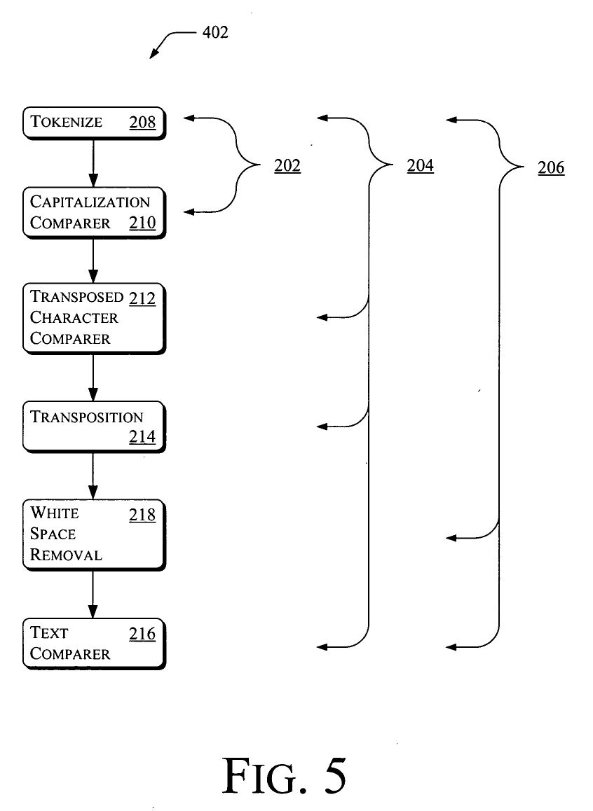

Subblock 306a executes an action. This action may be part of or have been a part of a similarity function. See, for example, FIG. 5. Here the composed function 402 is marked by the similarity functions from which the composed function was composed. This shows capitalization function 202 comprising tokenize action 208 and capitalization comparer action 210. It shows character transposition function 204 with tokenize action 208, transposed character comparer action 212, transposition action 214, and text comparer action 216. And it shows white space function with tokenize action 208, white space removal action 218, and text comparer action 216. Thus, executing the composed function may be performed action by action effective to perform multiple similarity functions.

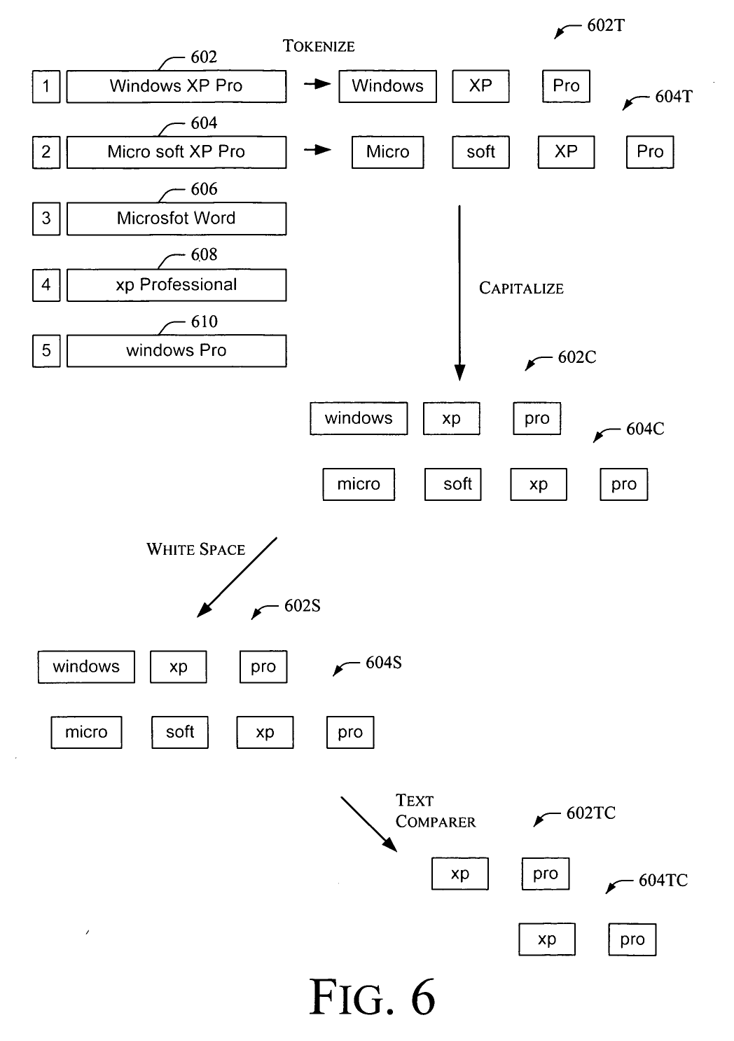

Execution of these similarity functions through their constituent actions is described using exemplary data records shown in FIG. 6. FIG. 6 shows five exemplary data records 602, 604, 606, 608, and 610 (marked also as rows 1, 2, 3, 4, and 5). Each of these pieces of data may be analyzed to determine if they are similar and so may refer to a same single entity—here a particular piece of software.

Similarity module 118 executes the tokenize action 208 on the first and second data record. In doing so, it executes the first action of composition function 402 of FIG. 4 and of all three similarity functions 202, 204, and 206 of FIGS. 2 and 5. The results are tokenized data shown at 602T and 604T. As shown, the data of each is broken (“tokenized”) into discrete chucks of data.

Subblock 306b retains the result of executing the action. The similarity module can retain the result of this and other actions for later use as input or output to other actions or that output a final result. Here the similarity module retains 602T and 604T in cache 122.

Subblock 306c retrieves the result. This result is used for at least one other action of the composed function or of one or more similarity functions. The result can be used to enable execution of multiple similarity functions or another use of the same similarity function.

Similarity module 118 next executes capitalization comparer 210 by setting all capitalizations to lower case. The results are shown at 602C and 604C in FIG. 6. Here subblock 306a is performed for another action from the same similarity function and that receives as input a result of a prior action also from that similarity function.

Subblock 306d executes actions of another similarity function without having to re-execute a previously-performed action. Thus, performance of the tokenize action once is effective for use in a second (and later a third or other) similarity function.

Next, the similarity module executes transposed character comparer action 212 to find transposed characters. The results are identical to 602C and 604C as no transpositions are found. Likewise, execution of transposition action 214 results look like 602C and 604C as no characters are identified as needing to be transposed. Next it executes white space removal action 218. While difficult to see, this action removes a space in front of tokenized “soft” from the second record. These results are shown at 602S and 604S. Next it executes text comparer action 216. The results indicate that two tokens from each record are the same. Here “Pro” and “Pro” and “XP” and “XP”. By so doing, the first and second records are shown to be similar. Similarity module 118 caches the results of each action performed at 306a, 306d, and 306e in cache 122.

The results of a performed action may also be retained and used for the same similarity function (here capitalization function 202) when used on a same set of data.

Subblock 306e executes actions of a same similarity function without having to re-execute the first action on data that the action has already been executed on. The tools enable execution of the same capitalization function over the first record and some other record without executing the tokenize action on the first record again. The similarity module is attempting to determine if the first record is also similar to the third record. The similarity module retrieves the cached 602T (tokenized data of record 602 in row 1), and any other same actions performed on the same data (capitalized data 602C and transposition character comparer and transposition 602TT). Thus, the similarity module does not have to perform the tokenize action again for the first record.

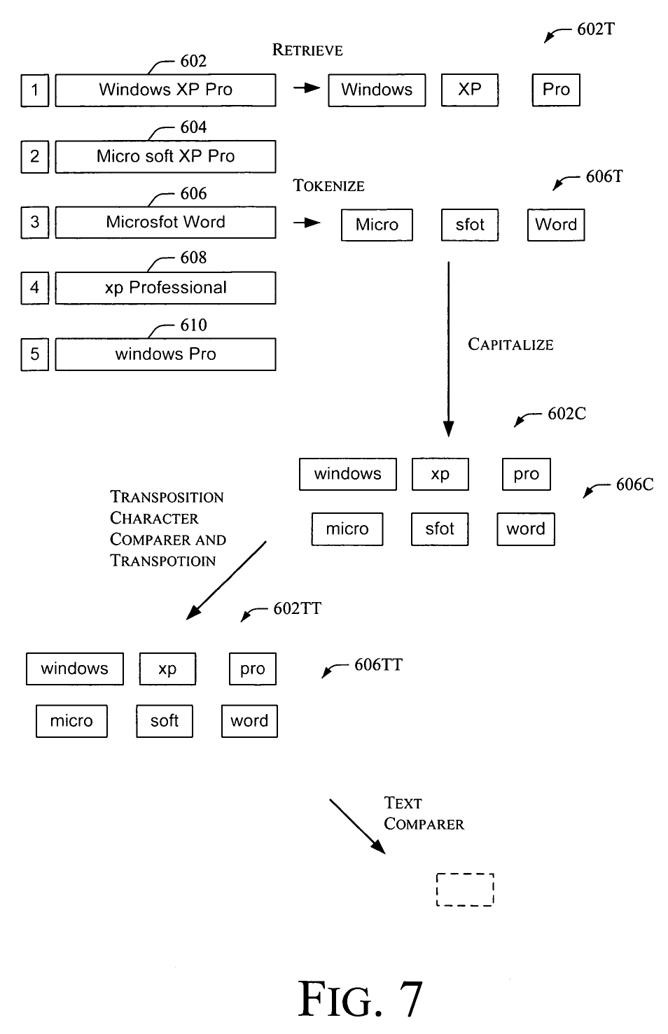

FIG. 7 shows the results of tokenizing the third record at 606T, capitalizing at 606C, and transposed characters identified and fixed at 606TT. Execution of the text comparer has no results, as no tokens of the first and third record are the same.

Note also that, if the similarity module is attempting to determine similarities between the second and third record, actions performed above may be reused for both of the records (e.g., tokenized data 604T and 606T).

Each of subblocks 306a, b, c, d, and e may be performed again. Here the similarity module continues through the five records and determines that the records 602, 604, 608, and 610 (in rows 1, 2, 4, and 5) are similar. It may then create a record showing canonicals for each of the similar records (e.g., a better identifier for that software: “Microsoft® Windows™ XY Professional”).

Flip-Window Algorithm

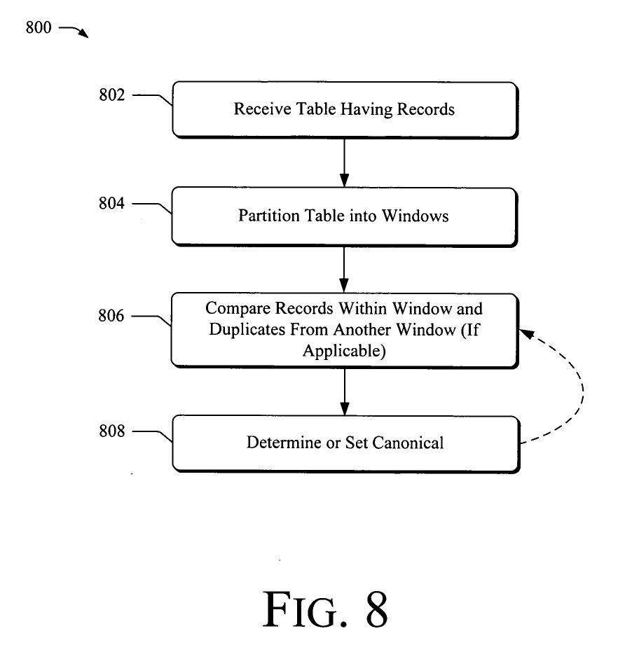

FIG. 8 is an exemplary process 800 for finding similar or duplicate records using a flip-window algorithm. It may be performed as part of a deduping operation of an extract, transform, and load (ETL) process or otherwise. It is illustrated as a series of blocks representing individual operations or acts performed by elements of operating environment 100 of FIG. 1, such as similarity module 118. This process may operate as part of or be an embodiment of various blocks or subblocks of FIG. 3 or may stand on its own.

Block 802 receives a table having records. The table has many rows of records, each of which has one or more columns of data, such as dirty records 120 of FIG. 1.

Block 804 partitions the table into windows. The number of windows will depend on the size of the windows and the table. If all of the windows (except usually the last window) are the same size, such as 50 records, the number of windows may be set equal to the number of records in the table divided by the number of records in the windows and rounded up to a nearest integer. Thus, if the table has 1005 records and the windows are 50 records (except the last one), then the number of windows is 1005/50=20.1, which is rounded up to 21. Thus, the first 20 windows have 50 records and the last one has five.

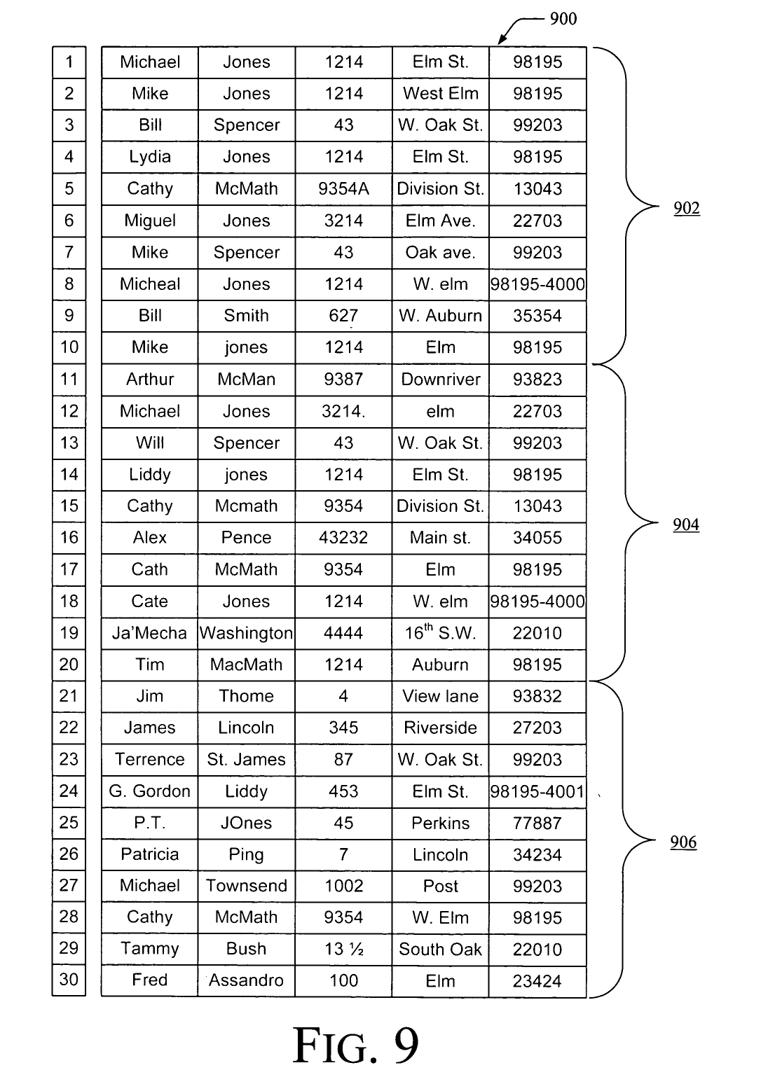

In an illustrated embodiment shown in FIG. 9, a table 900 of 30 records is shown. With a window size of 10 records, similarity module 118 partitions the table into three windows of 10 records each, first window 902, second window 904, and third window 906.

Block 806 compares records within a particular window to determine if any records in that window are similar or duplicates. Block 806 may do so using one or more similarity functions or actions or a composed function. It may also do so as set forth for block 306 or subblocks 306a, 306b, 306c, 306d and/or 306e. Block 806 may also compare records of a particular window with records from another window that were found to be duplicates. These windows may be adjoining in the table or performed in order but not adjoining, or otherwise.

For first window 902, similarity module 118 determines which of the records in the first 10-record window are likely duplicates, here records in rows 1, 2, 4, 8, and 10 are likely duplicates with each other, as are rows 3 and 7 with each other. The similarity module determine which are likely duplicates by comparing the first record with records 2-10, then the second record with records 3-10, then the third record with records 4-10, and so forth. It may also forgo comparing a particular record with the rest of the records if it has already been shown to be a duplicate. Thus, if record 1 and 2 are found to be duplicates, the similarity module may forgo comparing record 2 with records 3-10. In this example, then, similarity module 118 compares 1 with 2 and marks 1 and 2 as duplicates, then 1 with 3, marks 3 as not a duplicate of 1, then 1 with 4, and marks 4 as a duplicate of 1, then 1 with 5-7 and marks each as not a duplicate of 1, then 1 with 8 and marks it as a duplicate of 1, then 1 with 9 and marks it as not a duplicate of 1, and then 1 with 10 and marks it as a duplicate of 1. Because 2, 4, 8, and 10 are marked as potential duplicates of 1, the similarity module may proceed to compare record 3 with just 5, 6, 7, and 9. The similarity module marks 7 as a likely duplicate of 3 and then proceeds to compare 5 with 6 and 9 and then 6 with 9.

Block 808 sets or determines a canonical for duplicate records. Here the similarity module sets row 1 as a canonical for rows 1, 2, 4, 8, and 10 and 3 for rows 3 and 7. A canonical may be the best manner in which to describe data or be one of the records that have been analyzed. Determining a canonical may be performed in manners well-known in the art.

Blocks 806 and 808 may be repeated. Block 806, for instance, may be repeated for each window of the table. But block 806 may compare more records than just those of each window. As mentioned above, the similarity module may compare records of a window with other records found to have duplicates, such as a canonical for each set of duplicate records found in an immediately prior window.

For example, assume that the similarity module starts with a window of 10 records, window 904 of FIG. 9, and adds records that have a duplicate from the first window 902. Thus, the similarity module compares the records of second window 904 (records 11-20) with each other and also with records 1 and 3. Records 1 and 3 were set as canonicals for each of their respectively sets of duplicate records from window 902.

Here comparing the second window and prior duplicates generates the following sets of duplicates: 1, 14, and 18; 3 and 13; and 15 and 17. Thus, the second window produced three sets of duplicates, two of which have a record from the prior window.

This continues, such that canonicals are set as rows 1, 13, and 17, and are then analyzed along with records 21-30 from the third window 906. The result of analyzing this window provides one set of duplicates: 17 and 28. Thus, if another window of records (e.g., rows 31-40, not shown) were to be analyzed, only those rows and the immediately prior duplicate (here either 17 or 28) would be analyzed with rows 31-40.

Thus, the total number of times record pairs are analyzed in this embodiment is dependent on the number of duplicate found. Assume, for one case, that all of the records of a first window are duplicates. Block 806 compares the first record of the first window to the second through the last record of the first window. The second and later records do not need to be compared with each other because they are duplicates. Thus, 9 record pairs are analyzed in the first window. The second window has 10 records plus one canonical from the first window, and thus is 11 records long. If all of these are also duplicates with themselves but not the record of the first window, only 10 record pairs are analyzed. For the third flip-window, 10 analyses again would be needed if all of the records are duplicates of themselves but not the record from the prior window. In this case, the similarity module analyzes 29 records pairs (9+10+10).

Assume, in another case, that none of the records in the 30-record table are found to be duplicates. Here the similarity module may then compare each record of each window with each other record. This results, for each window of 10 records, in the following number of analyzed record pairs:
9+8+7+6+5+4+3+2+1=45.

This may also be represented as 9#. For all three iterations, this would result in analysis of 135 record pairs (3*45).

In another case, assume that all of each window's records have a single duplicate. Thus, for a window size of 10, the first window has 5 pairs of duplicates, which can be set to 5 canonicals for each window. The number of analyzed record pairs may be, if 1-5 are duplicates of each of 6-10: 1 with 2-10 for 9 pairs, 2 with 3-10 for 8 pairs, 3 with 4-10 for 7 pairs, 4 with 5-10 for 6 pairs, and 5 by 6-10 for 5 pairs. As 6-10 are duplicates of 1-5, respectively, the similarity module may forgo comparing 6 through 10 with each other. The results of this would be 9#−5#, or 45−15=30. For the next window if we assume the same, we have an initial window of 10 plus 5 canonicals for 15 records. If none of the next window's records are duplicates of the canonicals but are of themselves, then the number of record pairs analyzed would be 14#−5#=90. The third window, if like the second and not matching canonicals from the second window, would also have 90 analyzed pairs. The total for this example is 210 record pairs compared.

A sliding window algorithm, for the above cases, however, may require a number of analyzed record pairs sufficient to compare every record in each window with each other, multiplied by the number of windows. Thus, for a window size of 10 records and 30 total records, the sliding window algorithm may require 290 analyzed record pairs.

Process 800 may be used in conjunction with parts of process 300, such that analyzing a record a second or later time requires fewer resources. If record 1 is 11 compared with record 2, results of certain actions may be reused when analyzing record 1 against records 3-10. Similarly, analyzing record 2 against 3-10 may reuse certain actions performed when record 1 was compared with record 2. This may result in faster and/or fewer resources needed to analyze records for similarities.

### CONCLUSION

The above-described systems and methods may enable actions to be reused that are common to multiple similarity functions or can be performed multiple times by the same similarity function. These systems and methods may also compose similarity functions into a composed function that enables reuse of actions and permits comparison of records in one pass and/or without needing a merge operation. The number of record pairs analyzed may also be reduced using a flip-window algorithm. Any one of these many techniques may enable records to be cleansed in less time and/or with fewer resources. Although the system and method has been described in language specific to structural features and/or methodological acts, it is to be understood that the system and method defined in the appended claims is not necessarily limited to the specific features or acts described. Rather, the specific features and acts are disclosed as exemplary forms of implementing the claimed system and method.

1. A computer-implemented method comprising:
executing an action on first data and second data as part of a first similarity function, the first similarity function performed to determine a similarity between the first data and the second data; and
using a result of executing the action to enable:
execution of the first similarity function, where the first similarity function is performed to determine a similarity between the first data and third data, without having to execute the action on the first data; or
execution of a second similarity function that: is different from the first similarity function; requires execution of the action on the first data or the second data; and is performed to determine a similarity between the first data and the second data or fourth data without having to execute the action on the first data or the second data.

2. The method of claim 1, further comprising executing the second similarity function to determine a similarity between the first data and the second data without executing the action on the first data or the second data.

3. The method of claim 2, wherein the act of executing the action on the first and the second data as part of the first similarity function and the act of executing the second similarity function are both performed in a single execution of a composed function, the composed function comprising a single iteration of the action and other actions comprised by the first or second similarity function.

4. The method of claim 2, wherein the act of executing the second similarity function executes a second action on the first data and the second data and further comprising retaining a result of the second action to provide a second result and using the second result to enable execution of a third similarity function that: is different from the first similarity function and the second similarity function: requires execution of the second action on the first data or the second data; and is performed to determine a similarity between the first data and the second data or fourth data without having to execute the second action on the first data or the second data.

5. The method of claim 2, further comprising executing a third similarity function without executing the action on the first data or the second data, where the third similarity function: is different than the first similarity function and the second similarity function; requires execution of the action on the first data and the second data; and is performed to determine a similarity between the first data and the second data.

6. The method of claim 1, wherein the action tokenizes the first data and the second data.

7. The method of claim 1, further comprising performing the acts of executing and using as part of a deduping process of an extract, transform, and load process.

8. The method of claim 1, wherein and the act of using comprises making the result available as input to an action of the second similarity function or to an action of another iteration of the first similarity function.

9. The method of claim 1, further comprising executing the first similarity function to determine a similarity between the first data and the third data without executing the action on the first data and executing the second similarity function to determine a similarity between the first data and the second data without executing the action on the first. data or the second data.

10. One or more computer-readable media having computer-readable instructions therein that, when executed by a computer, cause the computer to perform acts comprising:
receiving multiple similarity functions performance of which are capable of producing multiple results, the multiple results capable of being merged into a single result with a merge operation; and
composing the multiple similarity functions into a single function capable of producing the single result.

11. The media of claim 10, wherein the act of receiving receives a user-selected similarity function having a user-selected constituent action and the act of composing composes the user-selected constituent action into the single function.

12. The media of claim 10, wherein two or more of the multiple similarity functions comprise a same action and the single function is capable of producing the single result with a single execution of the same action.

13. The media of claim 10, further comprising executing the single function effective to produce the single result with a single pass over the data.

14. The media of claim 10, wherein the act of composing comprises determining what actions are performed by each of the similarity functions and which of those actions are redundant, and ordering the actions that are not redundant.

15. A computer-implemented method comprising:
comparing records of a first window to provide one or more first sets of duplicate records;
comparing records of a second window and at least one duplicate record of each set of the first sets of duplicate records to provide one or more second sets of
duplicate records; and comparing records of a third window and at least one duplicate record of each set of the second sets of duplicate records to provide one or more third sets of duplicate records.

16. The method of claim 15, wherein each of the first window, the second window, and the third window do not share any records.

17. The method of claim 15, wherein the first, second, and third windows each comprise a first number of records, and further comprising receiving a table of a second number of records and partitioning the table into a third number of windows, where the third number is the second number divided by the first number and rounded up to a nearest integer, and wherein the first window, the second window, and third window are three of the third number of windows partitioning the table.

18. The method of claim 17, further comprising separately comparing records within each of the windows partitioning the table along with a duplicate record if the duplicate record is provided by comparing records of an adjoining window.

19. The method of claim 15, wherein the first window, the second window, and the third window are adjoining windows of a table of records.

20. The method of claim 15, further comprising determining a canonical record for each set of the second sets of duplicate records and wherein the act of comparing records of the third window compares records of the third window and the canonical record for each set of the second sets of duplicate records.
